(19) United States
(12) Patent Application Publication
(10) Pub. No.: US 2016/0234384 A1
(43) Pub. Date: Aug. 11, 2016

(54) EFFICIENT ALLOCATION AND USAGE OF COMMUNICATION CHANNELS FOR TEXT STREAMS

(71) Applicant: Kent S. Charugundla, New York, NY (US)

(72) Inventor: Kent S. Charugundla, New York, NY (US)

(21) Appl. No.: 15/132,055

(22) Filed: Apr. 18, 2016

Related U.S. Application Data
(63) Continuation of application No. 13/961,760, filed on Aug. 7, 2013, now abandoned.

(51) Int. Cl. H04M 3/42; G10L 15/26; H04M 1/247

(52) U.S. Cl. CPC H04M 3/42382; H04M 1/2475; G10L 15/265; H04M 2203/2011; H04M 2203/252; H04M 2203/558; H04M 2203/654; H04M 2207/203; H04M 2201/40

(57) ABSTRACT

A communication system capable of allocating resources to provide text services to IP telephone users upon receiving requests for text services during a telephone call or during the establishment of the telephone call. The system uses available resources for text services efficiently in that it allocates the resources upon receiving a request for text services and de-allocates the resources upon termination of the telephone call or upon receiving a request for termination of text services during the telephone call. A party to the telephone call can make a request for text services or make a request to terminate text services during the telephone call by activating a button on its IP phone.

This application is a continuation of application Ser. No. 13/961,760 filed on Aug. 7, 2013 entitled “Efficient Allocation And Usage Of Communication Channels For Text Streams,” which is incorporated herein by reference in its entirety.

### FIELD OF THE INVENTION

The present invention generally relates to the field of telecommunications. In particular, the present invention relates to a communication system that allocates resources for text services when requested and de-allocates said resources when termination of the text services has been requested.

### BACKGROUND OF TILE INVENTION

Telephone communication systems have experienced tremendous change in their architecture and design during the past decade. One important factor affecting telephone service is the continually evolving and ubiquitous communication network commonly referred to as the Internet. Telephone voice signals can now be routed through the Internet using the well accepted technique known as Voice over IP (VoIP), which allows voice signals (and other signals such as text, video, graphics) to be conveyed between parties in a telephone call. Telephones, which are used to transmit voice over the Internet are commonly known as IP phones whereby the telephone signals are formatted and transmitted in accordance with the Internet Protocol (IP). IP phones are used in communication systems that include networks such as the Internet that allow transmission and/or reception of different types of signals other than voice and digital data, which were the typical signals supported by legacy phone systems such as POTS (Plain Old Telephone System) or the PSTN (Public Switched Telephone Network). In many cases, the VoIP systems are combined with the POTS and the PSTN depending on the location of the users and the carriers from whom they subscribe for their telephone and Internet services.

Users of IP phones who are hearing impaired or who may have difficulty understanding the language of the person to whom they are speaking have the ability to receive the voice signals as text streams. Thus, for example, an IP phone user may take part in a telephone conversation where such user hears the voice signals and also sees (in real time) the text representation of the voice signal as an aid to improve his/her understanding of the voice signals. Even though many telephones are still part of the legacy systems (i.e., POTS and PSTN) referred to earlier, it is clear that many telephones will at least be able to provide text services as part of a set of features provided by the service providers; this is because, many phones have their signals, at some point, routed through an IP network even though such telephones are connected to local POTS or PSTN systems. Undoubtedly, the use of IP phones will continue to increase in the near future. Consequently, better and more efficient usage of the resources associated with text channels are needed.

Many IP phones have a feature that allows a user to request for text services through some type of mechanism (e.g., a push button—for certain IP phones—called a “selective URI,” button) on the IP phone. In such IP telephones when a user makes a request for text services (by pushing the selective URI, button, for example), the system is able to provide such services after garnering and configuring the resources needed to provide the text services feature. The resources comprise the equipment (e.g., transmitters, receivers, signal and microprocessors running on pertinent software), human agents by themselves or human agents in combination with voice recognition software that perform the real time conversion of voice signals to text, and the various communication channels (whether virtual or tangible) through which the text streams traverse.

A user, after having been provided text services, may at a later time, no longer desire text services. In many such cases, the user can make a request to terminate text services (again, for example, by pushing the selective UAL button). In current systems, upon receiving a request to terminate text services, the IP phone will stop displaying the text streams, but the resources allocated for the text services will continue to operate even after the user has requested for the termination of the text services. The agent and/or voice recognition software used to convert voice to text continue to operate; the equipment allocated for such services and, in many cases, the various communication channels allocated for the text services still exist even though they are not being used. Such usage or more precisely misusage—of resources when there is no actual need for them represents a wasteful and inefficient use of resources of the communication system.

### BRIEF SUMMARY OF THE INVENTION

The present invention provides a method and a system for efficient use of resources for text services (user selectable or system selectable) provided in a telephone call. The system allocates resources to implement the text services requested by a party to a telephone call and de-allocates said resources upon receiving a request to terminate the previously desired text services.

The method of the present invention first establishes a telephone call by a transceiver of the system of the present invention; the telephone call is initiated by equipment of a party originating a call. The system provides text services to a party requesting for such services; that is, voice signals being transmitted to the party are converted to text streams by a text generator and the resulting text streams are transmitted to the requesting party via the transceiver or transmitted by the text generator directly to the requesting party. A request for text services from at least one of the parties to the telephone call is represented as signaling information (generated by user equipment of the requesting party) associated with the telephone call and thus received by the transceiver from the telephone call, where said transceiver processes and interprets such signaling information in accordance with one or more protocol(s) being followed by the transceiver. The request may occur during the establishment of the telephone call or during the telephone call itself after it has been established by the transceiver.

A party may also request to terminate text services during the telephone call and the resulting signaling information from the telephone call for such a request is also received by the transceiver. Thus, the transceiver receives requests for text services and/or request to terminate text services from the telephone call in the form of signaling information associated with the telephone call.

A request for text services or a request to terminate text services is received as part of the signaling information associated with a telephone call or the establishment of a telephone call. The signaling information comprises information exchanged between the transceiver and equipment of parties to the telephone call. The signaling information is part of the information defined by the communication standard(s) and associated protocol(s) being followed by the system, the transceiver, and the equipment of the parties to the telephone call. The signaling information may be conveyed (i.e., transmitted and/or received) over communication channels that are different from the communication channels through which user information information being transmitted and/or received by parties to the telephone call) is conveyed. During the telephone call (i.e., after the call has been established), the system uses the signaling information to format, process and interpret the user information of the telephone call. During establishment of a call, (prior to the exchange of user information between the parties to the telephone call), the transceiver and other equipment of the system exchange signaling information (e.g., protocol procedures, handshaking procedures and other information defined by the communication standards being followed by the system and user equipment) to determine how to process, interpret, format and convey the user information once the call has been established.

The method of the present invention, upon receipt of a request for text services, allocates the resources needed to provide the text services for which a request was made. The text services may be provided to the requesting party for the entire duration of the telephone call or for a portion of the telephone call. However, during the telephone call, upon receipt of a request to terminate the text services, the transceiver does so and de-allocates the resources that were allocated for the now terminated text services.

The system of the present invention comprises a transceiver for transmitting and/or receiving at least voice signals of a telephone call. The system further comprises a text generator coupled to the transceiver for converting received voice signals of the telephone call into text streams and where the transceiver allocates resources for transmission of the text streams in response to one or more requests for text services from the telephone call and de-allocates resources in response to one or more requests for termination of the text services. The allocation or de-allocation of resources by the transceiver may be done automatically by the transceiver or may be done with the assistance of agents of the system who are continually monitoring the system for at least requests from established telephone calls or from telephone calls being established.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a block diagram of the communication system of the present invention.

FIG. 2 is a flow chart of the method of the present invention.

### DETAILED DESCRIPTION

The description of the communication subsystem and the method of selecting features of the present invention is disclosed herein using the following terms, terminology, definitions and abbreviations:

The term ‘text streams’ refers to readable text resulting from a voice recognition system (using voice recognition software and speech tuning algorithms) that analyzes and processes acoustics generated from voice signals. Alternatively, electrical signals representing voice signals can also be processed by such a voice recognition system to transcribe automatically electric signals representing words spoken by a person or words generated by a speaker or other voice-broadcasting device. The transcription can also be done by a third party agent of the system who transcribes in real time (with or without the assistance of voice recognition software and other software), or after a defined delay, voice signals destined for party who has requested text services.

A Server is a computer or computer system comprising of one or more processors, various blocks of memory, and supporting circuitry to process information and to interface with users or other servers.

The term “automatic” or “automatically” refers to a process of steps and/or act(s) or tasks performed by electrical, electronic or electromechanical devices, mechanical devices, machine or systems (including the system of the present invention) in response to information or signals inputted and/or received into such machines, devices or systems.

A communication network is any digital or analog network or any combination of such networks whereby transmission and reception of associated text, voice, video, and graphics can be achieved.

Telephone call or communications—a communication link established between at least two parties each having a communication equipment (e.g., cell phone, telephone, desktop or laptop computer, tablet) allowing each of the equipment to transmit and/or receive voice, text, video, graphics and various other forms of information through operation of said equipment by an entity (e.g., one or more persons, communication equipment) where the information is transmitted over one or more communication networks in accordance with the standards and protocol of such networks,

Party—communication equipment used to transmit and receive signals (e.g., voice, video, text, graphic) over one or more communication networks, Also, a person, machine/device or system operating said communication equipment and using resources being provided by a service provider (e.g., an Internet Service Provider (ISP)) to effectuate a telephone call or communications over one or more communication networks.

The terms user or users refer to an individual(s), groups of individuals, an organized entity such as a corportation, or a communication system or a subsystem thereof with the ability to transmit user information (e.g., voice, video, graphics, text) and/or receive user information during an established telephone call. A user can be a party to a telephone call that is established or in the process of being established.

Established telephone call or Established communications refers to the provision of various communication infrastructure equipment, communication channels, communication links and other resources owned and/or controlled (at least during a telephone call or during communications) by an owner or a controlling agent of the system to effectuate communications between the parties to a telephone call as per the standards and protocols of the one or more networks through which the signals of the telephone call traverse.

The term “couple” or “couple(d) to” as used herein refers to a path or a series of connected paths (permanent or temporary) that allow information (in one or more formats or signals to flow from one point or equipment in a communication network to another point within the same equipment or another equipment in the same or different communication network in accordance with the protocol(s) of the communication network(s).

The term Internet enabled device(s) relates to various personal communication equipment owned and/or used by users to convey information over the Internet. Examples of such equipment are laptops, telephones, cellular phones (e.g., srnartphones), tablets, desktop computers and other communication devices capable of gaining access to the Internet through the use of Internet browsers such as Explorer, Safari, Firefox, Windows Mobile, Netscape Navigator, Lynx, Symbian and receive information on only in their original formats, but also in Java, Flash, HTTP/S, TEXT and XML format, which are typically used by the Internet.

The term service provider refers to an entity or organization that owns and/or controls various communication equipment forming a communication system where said communication equipment provides communication services to subscribers in one or more communication network(s) in accordance with the standards and protocols of the communication network(s).

The term communication service(s) refers to specific sets of processing steps, processing procedures (also referred to as ‘features’) applied to received user generated communication signals performed by equipment owned and/or controlled by a service provider in accordance with protocols and communication standards of the one or more communication networks to which the service provider equipment is coupled.

The term text services refers to a particular type of communication services where voice signals destined for a party to a telephone call who has requested for such services are transcribed automatically or by an agent in combination with voice recognition software and speech tuning algorithms to text streams.

The term transceiver refers to communication equipment for transmitting and/or receiving voice, text, graphics, video, signaling information and other types of information over a communication network or a series of communication networks any one of which can be analog or digital communication networks or networks which combine analog and digital communication networks. The transceiver is capable of allocating and de-allocating resources, viz., equipment (e.g., databases, storage spaces, blocks of memory, processors (e.g., conversion equipment that convert voice to text), transmitters, receivers, communication channels, communication links, as needed or desired to provide communication services for the system. The operations of allocation and de-allocation performed by the transceiver may be done automatically in response to specific signaling information or sets of signaling information received by the transceiver in accordance with a protocol being followed or may be done with the assistance of agents of the system. The transceiver may be part of communication switch equipment used to provide communication services to subscribers of telephone services over the Internet and other communication networks such as the POTS and the PSTN.

Signaling information is information that is exchanged between equipment, of a communication system to assist and instruct the equipment on how to format, transmit/receive, process and interpret user information (e.g., voice, text, graphics, video). The signaling information is dictated by protocols of one or more communication standards being followed by the system.

The present invention provides a method and a system for efficient use of resources for text services (user selectable or system selectable) provided in a telephone call. The system allocates resources to implement the text services requested by a party to a telephone call and de-allocates said resources upon receiving a request to terminate the previously desired text services.

The method of the present invention first establishes a telephone call by a transceiver of the system of the present invention; the telephone call is initiated by equipment of a party originating the call. The system provides text services to a party requesting for such services; that is, voice signals being transmitted to the party are converted to text streams by a text generator and the resulting text streams are transmitted to the requesting party via the transceiver or transmitted by the text generator directly to the requesting party. A request for text services from at least one of the parties to the telephone call is represented as signaling information (generated by user equipment of the requesting party) associated with the telephone call and thus received by the transceiver from the telephone call, where said transceiver processes and interprets such signaling information in accordance with one or more protocol(s) being followed by the transceiver. The request may occur during the establishment of the telephone call or during the telephone call itself after it has been established by the transceiver. A party may also request to terminate text services during the telephone call and the resulting signaling information from the telephone call for such a request is also received by the transceiver. Thus, the transceiver receives requests for text services and/or request to terminate text services from the telephone call in the form of signaling information associated with the telephone call.

A request for text services or a request to terminate text services is received as part of the signaling information associated with a telephone call or the establishment of a telephone call. The signaling information comprises information exchanged between the transceiver and equipment of parties to the telephone call that are part of the information defined by the standard and protocol being followed by the system, the transceiver, and the equipment of the parties to the telephone call. The signaling information may be conveyed (i.e., transmitted and/or received) over communication channels that are different from the communication channels through which user information (i.e., information being transmitted and/or received by parties to the telephone call) is conveyed. During the telephone call (i.e., after the call has been established), the system uses the signaling information to format, process and interpret the user information of the telephone call, During establishment of a call, (prior to the exchange of user information between the parties to the telephone call), the transceiver and other equipment of the system exchange signaling information (e.g., protocol procedures, handshaking procedures and other information defined by the communication standards being followed by the system and user equipment) to determine how to process, interpret, format and convey the user information once the call has been established.

The method of the present invention, upon receipt of a request for text services, allocates the resources needed to provide the text services for which a request was made. The text services may be provided to the requesting party for the entire duration of the telephone call or for a portion of the telephone call. However, during the telephone call, upon receipt of a request to terminate the text services, the transceiver does so and de-allocates the resources that were allocated for the now terminated text services.

The system of the present invention comprises a transceiver for transmitting and/or receiving at least voice signals of a telephone call. The system further comprises a text generator coupled to the transceiver for converting received voice signals of the telephone call into text streams and where the transceiver allocates resources for transmission of the text streams in response to one or more requests for text services from the telephone call and de-allocates resources in response to one or more requests for termination of the text services. The allocation or de-allocation of resources by the transceiver may be done automatically by the transceiver or may be done with the assistance of agents of the system who may be continually monitoring the system for at least requests from established telephone calls or from telephone calls being established.

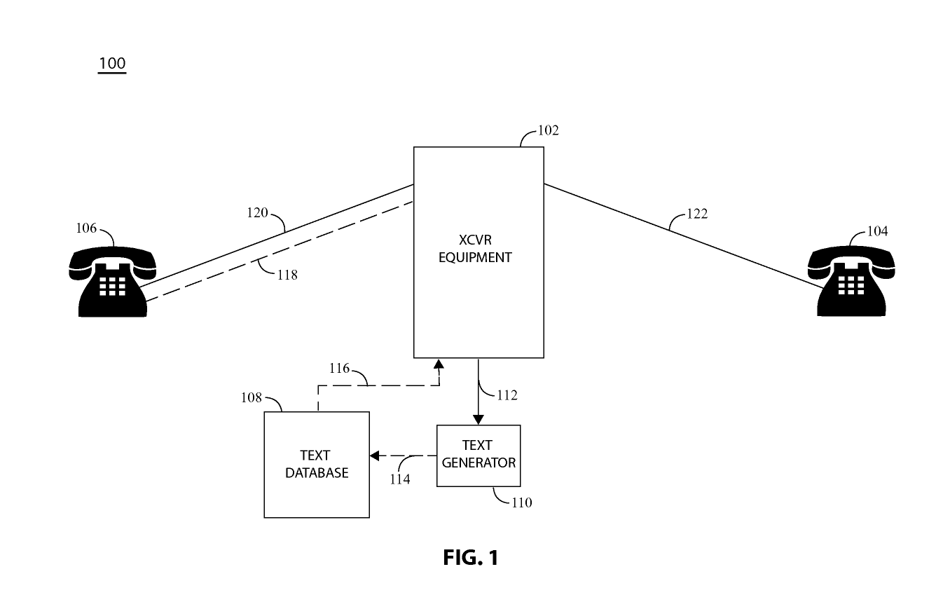

Referring to FIG. 1, there is shown a block diagram of the system of the present invention coupled to user equipment (e.g., IP phones) 104 and 106. For ease of explanation, it will be understood that LP phone 106 is being operated by a person who is hard of hearing, or by a person with difficulty understanding the language being used in a telephone conversation between her/him and a person operating IP phone 104. IP phone 106 is shown coupled to transceiver 102 via communication links 120 and 118. Communication link 120 is used to convey voice and other types of signals. IP phones 106 and 104 may be Internet enabled devices (e.g., desktop computer, laptop computer, tablet) other than IP telephones. User information traverses through communication link 120 between IP phone 106 and transceiver 102. Communication link 118 is a text channel representing the channel through which text streams from transceiver 102 traverse. Similarly, IP phone 104 is shown coupled to transceiver 102 via communication link 122. As with communication link 120, communication link 122 represents various communication channels, communication transmission, receiving and processing equipment that may be part of one or more communication systems (e.g., POTS, PSTN and/or the Internet).

Still referring to FIG. 1, voice signals from IP phone 104 are received by transceiver 102. At some point during the establishment of a telephone call between IP phones 104 and 106 or during an established telephone call between IP phones 104 and 106, transceiver 102 receives at least one request for text services from IP phone 106. The request may be transmitted over a signaling channel (not shown) that is part of communication link 120. In response to the request from IP phone 106, transceiver 102 garners the necessary software, hardware and equipment to (i) establish a text channel 118 for text services; (ii) couple via communication channel 112 to a text generator 110; (iii) route replicas of voice signals to be received b IP phone 106 to text generator 110 via communication channel 112; replicas of voice signals destined for IP telephone 106 are routed to text generator 110 and the original voice signals are allowed to be transmitted to IP telephone 106; (iv) route via communication channel 114 the resulting text streams from text generator 110 to text database 108 where the messages are store; and (v) route via communication channel 116 the resulting text streams through to IP phone 106 via text channel 118. The text channel and text communication paths are shown as dashed lines (text channel 118, text communication paths 114 and 116) to indicate that they are used as conduits or paths for text streams, These text communication paths are not necessarily fixed or permanent channels. Further, these text communication paths (114, 116) and text channel 118 can be activated, when needed, by transceiver 102 to comply with the text service requests by a party to the telephone call. When no longer needed these text communication paths and text channel 118 are de-activated.

Thus, the establishment of a text channel (e.g., channel 118) refers to the activation of equipment such as text generator 110 and activation of voice communication path 110 and text communication paths 114 and 116, Voice communication path 112 provides the voice signals to text generator 110, which transcribes the voice signals into text streams. The text streams are transmitted through text communication paths activated by the transceiver and the transceiver configures a text channel in accordance with a communication standard and one or more protocols of a communication network within which the transceiver resides. For example, the text channel 118 can be established in accordance with the communication standard(s) governing the Internet using the IP (Internet Protocol).

Text generator 110 may comprise equipment having voice recognition software, and speech tuning algorithms being executed on a server or similar equipment to automatically convert (i.e., transcribe) voice signals to text streams. Further, text generator 110 may be partially operated or totally operated by a human agent who transcribes, in real time, (or as per a system defined delay) the voice signals from IP phone 104 to text streams. Text generator thus can be an automatic transcription device or a device that automatically transcribes text but with assistance from a human agent; i.e., the agent can make corrections and/or edits of the automatically generated text streams. The output of text generator 110 is transferred to database 108 via text communication path 114. The text in database 108 can be transferred to transceiver 102 via text communication path 116 for transmission over test channel 118 to IP phone 106. Alternatively, text database 108 may contain transmission equipment that allows it to transmit the text streams for IP phone 106 directly to IP phone 106; such text stream may not necessarily be transmitted over text channel 118, but can be transmitted over another communication link (not shown) that is part of a communication network to which the database 108 belongs. Further, it will be readily understood that text database 108, text generator 110 and transceiver 102 may not necessarily be co-located; these equipment may be physically located at totally different sites relative to each other. For example, text database 108 may be part of the Internet whereas transceiver 102 may be part of a POTS or a PSTN system. The text channel 118 once activated is established in accordance with the standards and protocols governing the communication network of which transceiver 102 is part. Thus, for example, part of the establishment of text channel 116 involves operating said channel in accordance with the communication standard of the Internet and the Internet Protocol (IP) in the case where transceiver is part of the Internet,

Transceiver 102 may be implemented as a receiver, a transmitter and a processor in communication with the transmitter and receiver for processing voice, text, video, graphics and other signals. In particular, transceiver 102 can process voice signals to be transmitted by the transmitter, voice signals to be received by the receiver and text streams received from the text generator. The processing of such signals comprise manipulation of such signals in terms of their format, amplitude and other signal characteristics to allow such signals to traverse the communication network(s) coupled to the communication system of the present invention. The transceiver 102 of the system of the present invention is thus able to format the text streams in accordance with the Internet Protocol (IP).

Transceiver 102 as shown may be part of a communication network that may comprise the POTS and/or PSTN coupled to the Internet or various combinations thereof. For example, the transceiver may be part of the Internet, but the IP phones 104 and 106 may be coupled to local POTS or PSTN systems. Alternatively, the transceiver 102 may be part of a POTS or PSTN system that is coupled to the Internet to allow IP phones to be used in its system. It will be readily understood that FIG. 1 shows only two phones coupled to transceiver 102 for ease of explanation. It will be further understood that the communication system of the present invention may accommodate more than two phones simultaneously and may also accommodate conference calls between multiple parties.

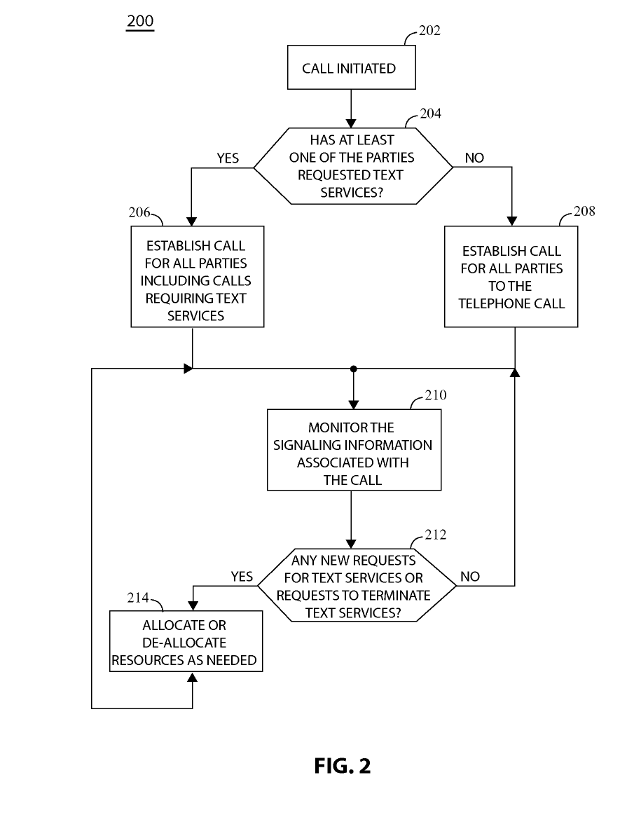

Referring now to FIG. 2, there is shown a flow chart of the method of the present invention. For simplicity and ease of explanation, the method of the present invention will be discussed in the context of FIG. 1 wherein a party at IP phone 104 is calling a party at IP phone 106. The party at IP phone 106 may be hard of hearing or may have difficulty understanding the language and/or speech pattern of the calling party at IP phone 104, In step 202 transceiver equipment detects that a call initiation from signaling information transmitted from IP phone 104 to IP phone 106. Transceiver 102 proceeds to establish a telephone call between IP phones 104 and 106. In so doing, in step 204, transceiver 102 determines whether one or both of the parties requires text services; this is done by transceiver 102 monitoring and checking the signaling information from both phones to see if such a request has been made. If such a request has been made, the method of the present invention moves to step 206.

For the sake of explanation, suppose transceiver 102 receives a request from IP phone 106 while establishing the telephone call between IP phone 106 and IP phone 104. In response to such a request, transceiver 102 in step 206, allocates the necessary and available resources to effectuate the text channels, and cause the text generator 110 and text database 114 to operate as discussed above. Further, transceiver 102 proceeds to establish the phone call between IP phones 104 and 106.

In step 210, during the telephone call, transceiver 102 is monitoring the signaling information being exchanged between the phones of the established telephone call to determine if there are any additional requests for text services or if there are requests to terminate already existing text services.

In step 212, the transceiver 102 detects whether any changes in text requirements have occurred; that is, whether there are new requests for text services or new requests for terminating text services. If there are no new requests, the telephone call is monitored being monitored until it ends or until a new request is detected.

In step 214, if as a result of monitoring the signaling information, a new request is detected, the transceiver 102 either allocates new resources for such a request or de-allocates resources in response to the request. Accordingly, text communication paths 114, 116 and text channel 118 and operation of the text generator 110 may be activated (in the case of a new request for text services) or text channels may be removed (or no longer activated) and the text generator de-activated in the case of a request to terminate text services. Also, voice communication path is either activated or de-activated depending on whether a request for text services or a request to terminate text services has been received by the transceiver 102. respectively. The resources that are de-activated or removed are available for use for future text service requests. When a resource is de-activated, it is no longer operated and the resources associated with its operation are not wasted. For example, in the case of a request for termination of text services, the text generator 110 does not perform transcription from voice to text because communication path 112 (which is carrying voice signals) is no longer available; thus, in such a case, there are no voice signals being inputted into text generator 110. Consequently, there are no text stream outputs and further, text communication paths 114 and 116 are no longer available. At the end of the telephone call, the resources allocated for the text services, which were not terminated during the telephone call are also de-allocated in the same manner.

Returning to step 204, if none of the parties has requested for text services during the establishment of the telephone call or during the established telephone call, the method of the present invention moves to step 210 and the system operates in the same manner as described above.

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects, but should be defined only in accordance with the following claims and their equivalents.

In addition, it should be understood that the figures in the attachments, which highlight the structure, methodology, functionality and advantages of the present invention, are presented for example purposes only. The present invention is sufficiently flexible and configurable, such that it may be implemented in ways other than that shown in the accompanying figures.

What is claimed is:

1. A method for providing, by a transceiver, text services to a telephone call, the method comprising:
establishing, by the transceiver, the telephone call;
providing, by the transceiver, text services to the telephone call based on at least one request for text services, the transceiver transmitting the text streams using resources allocated by the transceiver and where such resources are de-allocated by the transceiver upon receiving at least one request to terminate the text services.

2. The method of claim 1 where the transceiver is part of a communication system that is part of a communication network.

3. The method of claim 2 where the communication network is a digital communication network.

4. The method of claim 3 where the digital communication network is an Internet based communication network.

5. The method of claim 2 where the communication network is a POTS network.

6. The method of claim 2 where the communication network is a PSTN.

7. The method of claim I where the step of providing text services comprises:
monitoring signaling information of communication channels of the telephone call for text services requests;
establishing a text channel based on at least one request for the text services; and
de-activating the text channel based on a request to terminate the text services.

8. The method of claim 7 where the step of establishing a text channel comprises providing, by the transceiver, a text generator for transcribing voice signals of the telephone call to text streams and transmitting said text streams through text communication paths activated by the transceiver and configuring a text channel in accordance with a communication standard and one or more protocols of a communication network within which the transceiver resides.

9. The method of claim 7 where the step of removing a text channel comprises de-allocating resources associated with the text channel.

10. The method of claim 7 where the steps of establishing a text channel and removing a text channel are performed by the transceiver during the telephone call after the telephone call has been established.

11. The method of claim 7 where the step of establishing a text channel is performed by the transceiver prior to the telephone call having been established.

12. The method of claim 7 where the step of removing a text channel is performed after the telephone call has been terminated.

13. The method of claim 4 where the transceiver performs the step of providing text services to the telephone call in accordance with rules, protocols and communication standards of the Internet.

14. A communication system for providing text services to a telephone call, the system comprises:
a transceiver for transmitting and/or receiving at least voice signals of the telephone call; and
a text generator coupled to the transceiver for converting received voice signals of the telephone call into text streams and where the transceiver allocates resources for transmission of the text streams in response to one or more requests for text services from the telephone call and de-allocates resources in response to one or more requests for termination of text services.

15. The communication system of claim 14 further comprising a database coupled to the text generator for storing the text streams.

16. The communication system of claim 14 where the resources comprise communication channels coupling the transceiver to the text generator and communication channels through which the transceiver transmits the text streams.

17. The communication system of claim 14 where the transceiver comprises:
a receiver;
a transmitter; and
a processor in communication with the transmitter and the receiver for processing voice signals to be transmitted by the transmitter and voice signals received by the receiver and text streams received from the text generator.

18. The communication system of claim 14 where the transceiver formats the voice signals and the text streams in accordance with an IP.

19. The communication system of claim 14 where text generator comprises voice recognition system comprising software algorithms that automatically transcribe received voice signals of the telephone call to text streams.

20. The communication system of claim 19 further comprising an agent operating in combination with the voice recognition system to assist in the transcribing of received voice signals of the telephone call.
